(19) United States
(12) Patent Application Publication
(10) Pub. No.: US 2013/0223073 A1
(43) Pub. Date: Aug. 29, 2013

(54) Lighting Fixture

(71) Applicants: Toshiba Lightning & Technology Corporation, (US); Kabushiki Kaisha Toshiba, (US)

(72) Inventors: Junya Hayashi, Kanagawa (JP); Hirokazu Yamada, Kanagawa (JP)

(73) Assignees: KABUSHIKI KAISHA TOSHIBA, Tokyo (JP); TOSHIBA LIGHTING & TECHNOLOGY CORPORATION, Yokosuka-shi (JP)

(21) Appl. No.: 13/780,572

(22) Filed: Feb. 28, 2013

(30) Foreign Application Priority Data
Feb. 29, 2012 (JP) 2012-044636

(51) Int. Cl. F21V 21/00

(52) U.S. Cl. CPC F21V 21/00
USPC 362/249.02; 362/382

(57) ABSTRACT

A lighting fixture 1 according to the embodiment includes a fixture main body 10, a power supply unit, and an organic Electro-Luminescence panel 20. The fixture main body 10 has a planar shape. The power supply unit is arranged on an upper surface which is a side facing to an attaching target to which the fixture main body 10 is attached, and in a center portion of the fixture main body 10. The organic Electro-Luminescence panel 20 is arranged at the fixture main body 10, is connected to the power supply unit, and radiates light in the lower surface direction at least which is the side opposite to the side facing to the attaching target.

### CROSS-REFERENCE TO RELATED APPLICATION

This application is based upon and claims the benefit of priority from the Japanese Patent Application No. 2012-044636 filed on Feb. 29, 2012, the entire contents of all of which are incorporated herein by reference.

### FIELD

Embodiments described herein relate generally to a lighting fixture.

### BACKGROUND

In recent years a lighting fixture in which an organic Electro-Luminescence (EL) panel is used as a light source for lighting is in practical use. The organic EL panel has the thickness of approximately several millimeters.

However, in the lighting fixture, a lighting circuit for lighting the light source, power lines for supplying power to the light source, and the like are arranged in addition to the light source. For this reason, it was difficult to make a lighting fixture in which the organic EL panel is used as the light source for lighting have an appearance which provides a comfortable feeling to a user by making, for example, the lighting fixture entirely thin, or the like.

An object of the exemplary embodiments is to provide a lighting fixture which is able to provide a comfortable feeling in appearance for a user.

### DESCRIPTION OF THE DRAWINGS

FIG. 1 is a perspective view of a lighting fixture according to a first embodiment.

FIG. 2 is a bottom view of a fixture main body which is included in the lighting fixture according to the first embodiment.

FIG. 3 is a top view of the fixture main body which is included in the lighting fixture according to the first embodiment.

FIG. 4 is a side view of the fixture main body which is included in the lighting fixture according to the first embodiment.

FIG. 5A is a diagram which illustrates a configuration example of an organic EL panel which is included in the lighting fixture according to the first embodiment.

FIG. 5B is a diagram which illustrates a configuration example of the organic EL panel which is included in the lighting fixture according to the first embodiment.

FIG. 6 is a diagram which illustrates an example of an attaching position of the organic EL panel which is included in the lighting fixture according to the first embodiment.

FIG. 7 is a diagram which illustrates an example of an attaching position of an LED light source which is included in the lighting fixture according to the first embodiment.

FIG. 8 is a diagram which illustrates an example of an opening portion which is provided in the fixture main body which is included in the lighting fixture according to the first embodiment.

FIG. 9 is a perspective view of a lighting fixture according to a second embodiment.

FIG. 10 is a top view of a fixture main body of the lighting fixture according to the second embodiment.

FIG. 11 is a diagram which illustrates a configuration example of an organic EL panel which is included in the lighting fixture according to the second embodiment.

### DETAILED DESCRIPTION

A lighting fixture according to embodiments includes a fixture main body, a power supply unit, and an organic Electro-Luminescence panel. The fixture main body has a planar shape. The power supply unit is arranged on an upper surface which is a side facing to an attaching target to which the fixture main body is attached, and in a center portion of the fixture main body. The organic Electro-Luminescence panel is arranged at the fixture main body, is connected to the power supply unit, and radiates light in a direction of the lower surface at least as the side opposite to the side facing to the attaching target.

In addition, the lighting fixture according to the embodiments may further include a light emitting diode light source unit which is arranged at the center portion of the fixture main body by protruding from the upper surface side to the side facing to the attaching target, is connected to the power supply unit, and radiates light in the lower surface direction using a light distribution angle which is smaller than that of the organic Electro-Luminescence panel. In this case, the organic Electro-Luminescence panel is arranged at a peripheral portion which is the periphery of the center portion of the fixture main body.

In addition, the organic Electro-Luminescence panel and the light emitting diode light source unit which are included in the lighting fixture according to the embodiments may have approximately the same intensity of luminous flux.

In addition, the organic Electro-Luminescence panel which is included in the lighting fixture according to the embodiments may be in a transparent state when the light gets turned off.

In addition, the organic Electro-Luminescence panel which is included in the lighting fixture according to the embodiments may radiate directions of the lower surface and the upper surface when the light gets turned on.

In addition, the lighting fixture according to the embodiments may further include an opening portion which is formed on a plane of the fixture main body, and where an opening area has a predetermined ratio or more of an area of the plane.

Hereinafter, embodiments of the lighting fixture will be described in detail with reference to accompanying drawings.

### First Embodiment

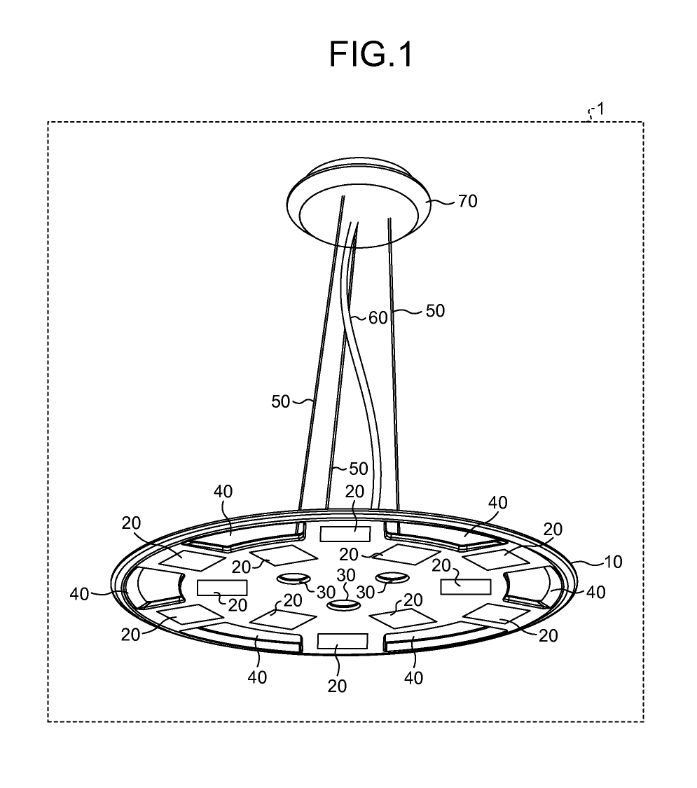

First, an appearance of a lighting fixture according to a first embodiment will be described with reference to FIGS. 1 to 4.

### Appearance of Lighting Fixture According to First Embodiment

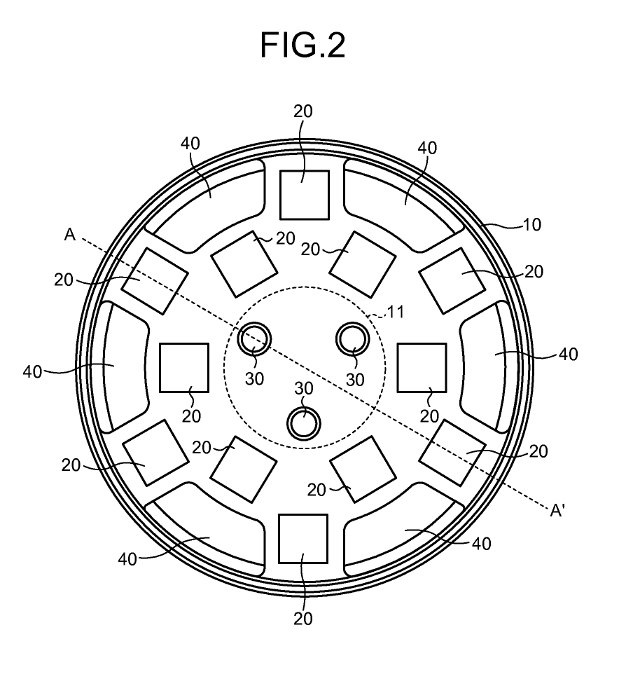

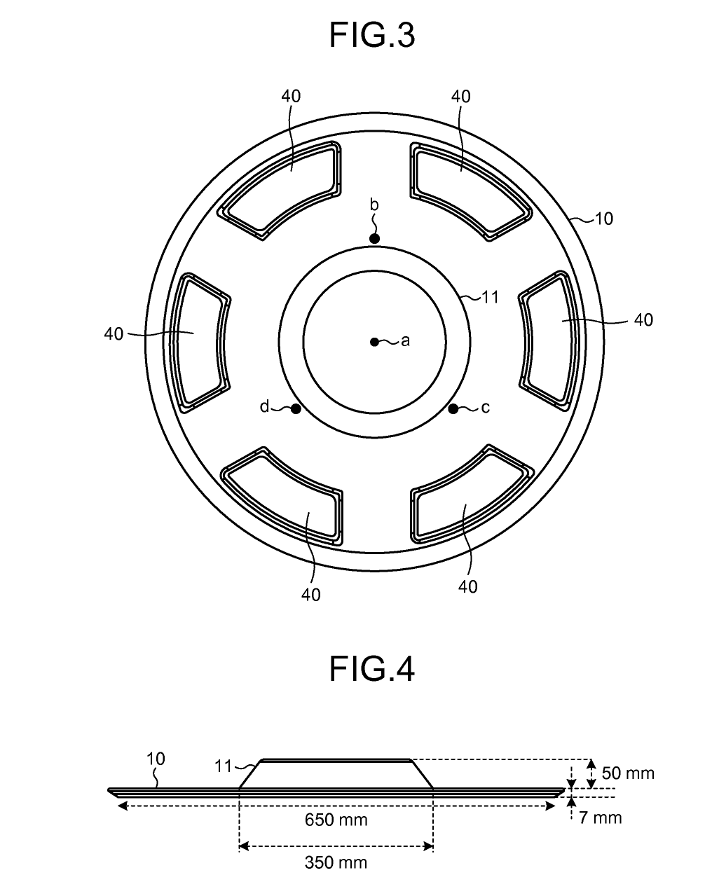

FIG. 1 is a perspective view of the lighting fixture according to the first embodiment. FIG. 2 is a bottom view of a fixture main body which is included in the lighting fixture according to the first embodiment. FIG. 3 is a top view of the fixture main body which is included in the lighting fixture according to the first embodiment, and FIG. 4 is a side view of the fixture main body which is included in the lighting fixture according to the first embodiment.

As illustrated in FIG. 1, the lighting fixture 1 according to the first embodiment includes a fixture main body 10, an organic Electro-Luminescence (EL) panel 20, a light emitting diode (LED) light source unit 30, and an opening portion 40. In addition, hereinafter, the organic Electro-Luminescence panel 20 will be described as an organic EL panel 20, and the light emitting diode light source unit 30 will be described as an LED light source unit 30.

As illustrated in FIG. 1, the fixture main body 10 is connected to an attaching portion 70 through three wires 50. The attaching portion 70 is supported in a state of being directly attached to a ceiling plane which is not shown. In addition, a power line 60 which is illustrated in FIG. 1 is connected to a power supply unit which will be described later, and is inserted into a power supply terminal block in the attaching portion 70. In addition, the fixture main body 10 may be attached to the ceiling plane by being embedded. In addition, an attaching target to which the fixture main body 10 is attached may be, for example, a post, a wall, or the like, without being limited to the ceiling plane.

The fixture main body 10 has a planar shape. In addition, the power supply unit which will be described later is arranged on an upper surface which is aside facing to an attaching target to which the fixture main body 10 is attached, and in a center portion of the fixture main body 10. For example, according to the first embodiment, as illustrated in FIGS. 3 and 4, a center cover 11 which covers the power supply unit which is arranged at the center portion is attached to the center of the upper surface of the fixture main body 10. As illustrated in FIG. 4, the fixture main body 10 to which the center cover 11 is attached has an appearance that the upper surface side at the center is protruded. For example, as illustrated in FIG. 4, the fixture main body 10 is a flat circular truncated cone in which the thickness is 7 mm, and the diameter of the bottom face is 650 mm. In addition, two horizontal line patterns are given to the side surface of the fixture main body 10 which is illustrated in FIG. 4. In addition, for example, as illustrated in FIG. 4, the center cover 11, which is attached to the upper surface side at the center of the fixture main body 10, is a circular truncated cone in which the thickness is 50 mm, and the diameter of a bottom face is 350 mm. In addition, dimensions and shapes of the fixture main body 10 and the center cover 11 are only examples, and are not limited to these.

As illustrated in FIG. 4, the fixture main body 10 to which the center cover 11 is attached has a shape in which the periphery of the center cover 11 is equally thin, the upper surface side of the center cover 11 is thick, and the lower surface is entirely planar, when seen from the side. The fixture main body 10 is formed of, for example, rigid metal, rigid resin with a transmittance property, or the like. In addition, according to the first embodiment, the power supply unit may be arranged at the center of the upper surface of the fixture main body 10 without attaching the center cover 11.

The organic EL panel 20 is arranged at the fixture main body 10, and is connected to the power supply unit. In addition, the organic EL panel 20 radiates light in the lower surface direction as the opposite side to the side facing to the attaching target. In addition, the organic EL panel 20 may also radiate the side surface direction and the upper side direction, not only the lower side direction.

According to the first embodiment, the organic EL panel 20 is arranged at the peripheral portion which is the periphery of the center portion of the fixture main body 10. For example, the organic EL panel 20 is a light source which uses an Organic light emitting diode (OLED). According to the first embodiment, as illustrated in FIGS. 1 and 2, six organic EL panels 20 as a first panel group which surrounds the periphery of the center portion of the fixture main body 10 are arranged on a concentric circle around the center of the fixture main body 10 in every 60 degrees. In addition, in FIG. 2 as the bottom view, a position corresponding to the center cover 11 is denoted by a dotted circle.

In addition, according to the first embodiment, as illustrated in FIGS. 1 and 2, as a second panel group which surrounds the first panel group, six organic EL panels 20 are arranged on a concentric circle around the center of the fixture main body 10 in every 60 degrees. That is, a radius of the concentric circle at which the second panel group is arranged is larger than that of the concentric circle at which the first panel group is arranged. In addition, as illustrated in FIGS. 1 and 2, a starting point at which the second panel group is arranged is a position which is deviated by 30 degrees from a starting point at which the first panel group is arranged. In addition, the number, and arranging position of the organic EL panel 20 which is exemplified in FIG. 1 or 2 are merely examples, and the number, and arranging position of the organic EL panel 20 which are arranged at the peripheral portion are not limited to these.

The LED light source unit 30 is arranged on the center portion of the fixture main body 10 by protruding to the upper surface side, and is connected to the power supply unit. In addition, the LED light source unit 30 radiates light in the lower surface direction using a light distribution angle which is smaller than that of the organic EL panel 20. The LED light source unit 30 is a light source which uses an LED element. According to the first embodiment, as illustrated in FIGS. 1 and 2, three LED light source units 30 are arranged on a concentric circle around the center of the fixture main body 10 in every 120 degrees in the center cover 11. The radius of the concentric circle at which the three LED light source units 30 are arranged is smaller than that of the bottom face of the center cover 11. In addition, as illustrated in FIGS. 1 and 2, a starting point at which the three LED light source units 30 are arranged is a position which is deviated by 30 degrees from a starting point at which the first panel group is arranged.

In addition, the number, and the arranging position of the LED light source unit 30 which is exemplified in FIG. 1 or 2 are merely examples, and the number, and the arranging position of the LED light source unit 30 which are arranged at the center portion are not limited to these. In addition, according to the first embodiment, the LED light source unit 30 may not be arranged as the light source. In such a case, the organic EL panel 20 may also be arranged at the center portion.

In addition, opening portions 40 are formed on the plane of the fixture main body 10 . According to the first embodiment, as illustrated in FIGS. 1 to 3, six opening portions 40 are arranged on the plane of the fixture main body 10 in every 60 degrees between the organic EL panels 20 which configure the second panel group. Here, the six opening portions 40 illustrated in FIGS. 1 to 3 are formed in the fixture main body 10 so that the opening area has a predetermined ratio or more to the area of the fixture main body 10. Specifically, a total opening area of the six opening portions 40 is an area of 10% or more of the area of the fixture main body 10. By providing the opening portion 40, a user who is present at the lower part of the lighting fixture 1 which is attached to the ceiling plane can view the ceiling plane from the opening portion 40. For example, as illustrated in FIG. 1, a part of the wires 50 can be viewed from the opening portion 40 by a user. An example of the dimension of the opening portion 40 which is illustrated in FIGS. 1 to 3 will be described later.

In addition, the power line 60 is inserted into the center cover 11 through a hole “a” which is illustrated in FIG. 3. As illustrated in FIG. 3, the hole “a” is provided at a center of the center cover 11. In addition, the three wires 50 are connected to the attaching portion 70 through a hole “b”, a hole “c”, and a hole “d” which are illustrated in FIG. 3, respectively. For example, a spherical body of which the radius is larger than that of the respective hole “b”, hole “c”, and hole “d” is attached to the respective tip end of the three wires 50, and due to the spherical body, the fixture main body 10 is held. For example, as illustrated in FIG. 3, the holes “b”, “c”, and “d” are provided in every 120 degrees in the periphery of the center cover 11.

### Detailed Description of Each Unit of Lighting Fixture According to First Embodiment

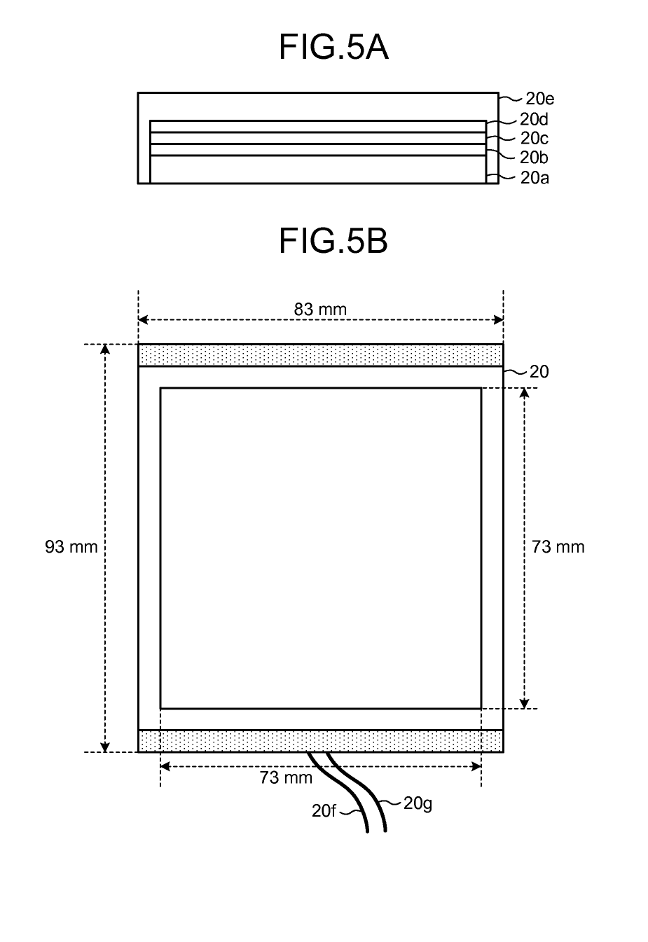

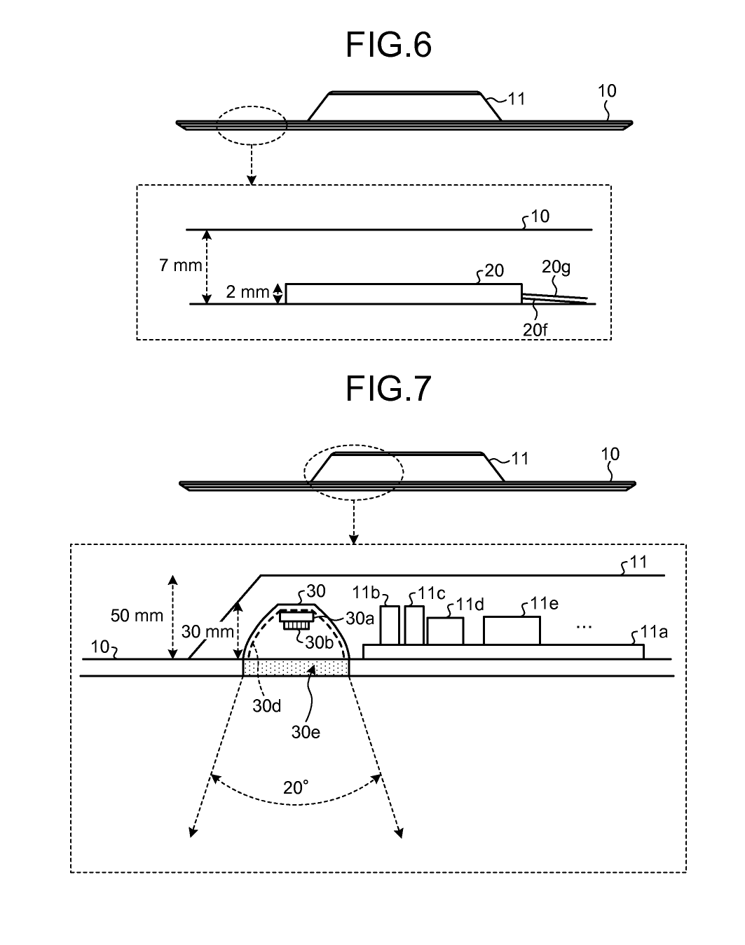

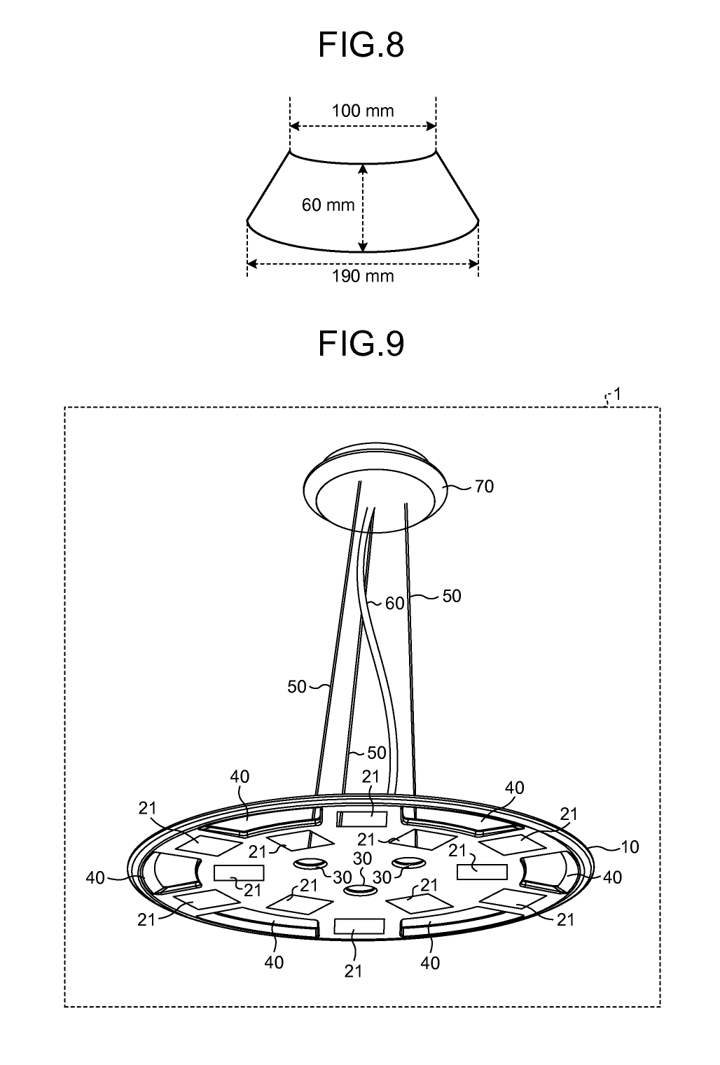

Subsequently, the organic EL panels 20 which are arranged in the peripheral portion, the LED light source units 30 which are arranged in the center cover 11, the power supply unit and opening portion 40 which are arranged in the center cover 11, and the like will be described using FIGS. 5 to 8. FIGS. 5A and 5B are diagrams which illustrate configuration examples of the organic EL panel which is included in the lighting fixture according to the first embodiment, and FIG. 6 is a diagram which illustrates an example of an attaching position of the organic EL panel which is included in the lighting fixture according to the first embodiment. FIG. 7 is a diagram which illustrates an example of an attaching portion of the LED light source which is included in the lighting fixture according to the first embodiment. FIG. 8 is a diagram which illustrates an example of the opening portion which is provided in the fixture main body which is included in the lighting fixture according to the first embodiment.

As illustrated in FIG. 5A, the organic EL panel 20 is configured by a substrate 20a, an organic EL element in which an anodic layer 20b, an organic EL light emitting layer 20c, and a cathode layer 20d are laminated on the substrate 20a, and a sealing member 20e. The substrate 20a is formed by a glass plate with a transmittance property, polyethylene terephthalate (PET) resin, or the like. The anodic layer 20b is formed by laminating tin-doped indium oxide (ITO) with a transmittance property, or indium zinc oxide (IZO) on the substrate 20a.

The organic EL light emitting layer 20c is formed on a formation region of the anodic layer 20b. The organic EL light emitting layer 20c is configured as a white light emitting layer by sequentially laminating a hole transport layer, a light emitting layer, and an electron injection layer which are not shown. In order to make luminous color a white color, there is a method of laminating, or mixing an organic compound which emits each light of red, green, and blue as a light emitting layer, a method of laminating, or mixing an organic compound which emits light of blue and yellow which are in a relationship of a complementary color, or the like. Hereinafter, a case in which luminescence materials which emit light of blue and yellow are laminated will be described.

In the hole transport layer, for example, a triphenyl diamine derivative is used. In the light emitting layer, for example, the triphenyl diamine derivative is used as a material of the yellow light emitting layer, and a tetracine derivative is used as a dopant material. In addition, in the light emitting layer, for example, an anthracene derivative is used as a material of the blue light emitting layer, and a perilene derivative is used as a dopant material. In the electron injection layer, for example, lithium fluoride is used. In addition, the layer configuration and materials of the organic EL light emitting layer 20c are not limited to above descriptions, and it is possible to adopt various layer configurations, or materials according to a design. For example, the organic EL light emitting layer 20c may be configured only by the light emitting layer.

The cathode layer 20d is formed on a formation region of the organic EL light emitting layer 20c. The cathode layer 20d is, for example, formed of metal with high reflectivity of light, and the metal being aluminum, magnesium, a magnesium-aluminum alloy, or the like.

The anodic layer 20b, the organic EL light emitting layer 20c, and the cathode layer 20d are sealed airtight by the plate-shaped sealing member 20e which is adhered to the outer peripheral portion of the substrate 20a using an adhesive. The sealing member 20e is formed, for example, by glass with a transmittance property. In addition, the sealing member 20e may be formed using a material such as metal.

According to the first embodiment, as illustrated in FIG. 5B, the organic EL panel 20 is formed in a rectangular shape in which the length is 93 mm, and the width is 83 mm. Here, as illustrated in FIG. 5B, the light emitting surface of the organic EL panel 20 is a square of 73 mm. The organic EL panel 20 illustrated in FIG. 2 is arranged, for example, such that the light emitting surface of the square 73 mm is located at a opening portion for a square panel of 73 mm which is formed on the lower surface of the plane of the fixture main body 10. In addition, the organic EL panel 20 which is illustrated in FIG. 2 is held in the fixture main body 10 by the outer peripheral portion of the light emitting surface which is formed by the substrate 20a, and the sealing member 20e.

In FIG. 5B, portions which are denoted by dotted rectangular shape in the outer peripheral portion of the light emitting surface denotes a place at which power supply terminals which are connected to the anodic layer 20b and the cathode layer 20d, respectively is arranged. These power supply terminals are connected to wiring 20f and wiring 20g illustrated in FIG. 5B. In addition, the organic EL panel 20 which is illustrated in FIG. 5B is manufactured as a cassette in which a power receiving terminal which can be connected to the power supply terminal (not shown) is provided so that twelve panels can be individually exchanged.

FIG. 6 is a view in which the outer peripheral portion of the fixture main body 10 is enlarged in a cut plane of the fixture main body 10 which is cut along line AA′ which is illustrated in FIG. 2. As illustrated in FIG. 6, a space of which the thickness is 7 mm is formed in the peripheral portion of the fixture main body 10, and the organic EL panel 20 of which the thickness is 2 mm is arranged in the space. In addition, the wiring 20f and wiring 20g of the organic EL panel 20 are wired toward the center portion of the fixture main body 10.

In addition, the dimensions of the organic EL panel 20 which are exemplified in FIGS. 5B and 6 are merely examples, and the dimensions of the organic EL panel 20 are not limited to these. In addition, in the above descriptions, a case in which the organic EL panel 20 is arranged at the opening portion for panel which is formed in the fixture main body 10 is described. However, the organic EL panel 20 may be placed, for example, on the lower surface of the fixture main body 10 which is formed using a material with a transmittance property from above. In addition, the first embodiment may be a case, for example, in which the plurality of organic EL panels 20 are arranged on a plate which is formed using a material with a transmittance property, and forms a doughnut shape in order to avoid the LED light source unit 30, and the plate is attached to the lower surface of the fixture main body 10. In addition, according to the first embodiment, a case in which there is no level difference between the lower surface of the organic EL panel 20 and the lower surface of the fixture main body 10 is described. However, the first embodiment may be a case, for example, in which the lower surface of the organic EL panel 20 slightly protrudes to the lower surface direction of the fixture main body 10. In addition, the first embodiment may be a case in which the organic EL panel 20 is not manufactured as the cassette which can be individually exchanged.

FIG. 7 is a diagram in which a part of the center portion of the fixture main body 10 at which the LED light source unit 30 is arranged is enlarged in a cut plane of the fixture main body 10 which is cut along line AA′ as illustrated in FIG. 2. As illustrated in FIG. 7, the LED light source unit 30 includes, for example, an LED element 30b which is formed on a substrate 30a, a reflective plate 30d and a lens 30e which adjust a light distribution angle of light which is radiated toward the lower surface direction from the LED element 30b. In addition, at least a power supply unit is arranged in the center cover 11. For example, as illustrated in FIG. 7, the center cover accommodates lighting circuits 11b and 11c which are connected to the organic EL panel 20, and a lighting circuit 11d which is connected to the LED light source unit 30. The lighting circuit lib is connected to the above described first panel group, and the lighting circuit 11c is connected to the above described second panel group. For example, the wiring 20f and wiring 20g from the first panel group are connected to the lighting circuit 11b, and the wiring 20f and wiring 20g from the second panel group are connected to the lighting circuit 11c. In addition, wiring from the three LED light source units 30 (not shown) is connected to the lighting circuit 11d.

In addition, for example, as illustrated in FIG. 7, a control circuit 11e which controls, through the lighting circuits 11b, 11c, and 11d, luminous flux of the organic EL panel 20 and the LED light source unit 30, or the like, is arranged in the center cover 11. As illustrated in FIG. 7, the lighting circuits 11b, 11c, and 11d, the control circuit 11e, and the like are formed on a substrate 11a, and function as the power supply unit of the lighting fixture 1.

In addition, the LED light source unit 30 is arranged in the center cover 11 by protruding to the upper surface side in the center portion of the fixture main body 10. In an example in FIG. 7, “substrate 30a, LED element 30b, and reflective plate 30d” in which the thickness is 30 mm are accommodated in a space of the center cover 11 in which the thickness is 50 mm. In addition, the first embodiment may be a case in which the substrate 30a, the LED element 30b, and “a part of reflective plate 30d” are accommodated in the center cover 11, or a case in which the substrate 30a, the LED element 30b, the reflective plate 30d, and the lens 30e are accommodated in the center cover 11. In addition, the thickness of the LED light source unit 30 which is accommodated in the center cover 11 is merely an example, and the thickness is not limited to the above described value.

Here, the light distribution angle of light which is radiated to the lower surface direction from the LED light source unit 30 is adjusted to a light distribution angle which is smaller than the light distribution angle of the organic EL panel 20 by the reflective plate 30d and the lens 30e. Since the organic EL panel 20 is a surface light source, a light distribution angle thereof is close to equal diffusion, and is wide. According to the first embodiment, the light distribution angle of the LED light source unit 30 is adjusted to, for example, approximately to 20 degrees which is smaller than the wide light distribution angle of the organic EL panel 20, as illustrated in FIG. 7.

In addition, the first embodiment may be a case in which the light distribution angle of light which is radiated to the lower surface direction from the LED light source unit 30 is not adjusted to be small. For example, the first embodiment may be a case in which the light distribution angle of light which is radiated to the lower surface direction from the LED light source unit 30 is adjusted to a larger light distribution angle than the light distribution angle of the organic EL panel 20. In addition, the first embodiment may be a case in which the reflective plate 30d, or the lens 30e is not provided in the LED light source unit 30.

In addition, in the first embodiment, the organic EL panel 20 and the LED light source unit 30 have approximately the same intensity of luminous flux. For example, in the first embodiment, twelve pieces of organic EL panels 20 of which the luminous flux is 50 lumens per piece are used, and three LED light source units 30 of which the luminous flux is 200 lumens per one unit are used. In this manner, both a total luminous flux in which the luminous flux of the twelve pieces of organic EL panels 20 are added up and a total luminous flux in which the luminous flux of three LED light source units 30 are added up are 600 lumens. The lighting circuits 11b, 11c, and 11d flow a current in which the twelve pieces of organic EL panels 20 and the three LED light source units 30 have the equal brightness by a control of the control circuit lie when lighting all thereof.

In addition, the control circuit lie individually adjusts a luminous intensity of the organic EL panel 20, and a luminous intensity of the LED light source unit 30 by controlling the lighting circuits 11b, 11c, and 11d. For example, the lighting circuit 11e adjusts such that both a total luminous flux in which the luminous flux of the twelve pieces of organic EL panels 20 are added up and a total luminous flux in which the luminous flux of three LED light source units 30 are added up are 300 lumens. In addition, for example, the control circuit lie lights up only the three LED light source units 30 and the six pieces of first panel group, or only the six pieces of second panel group.

In addition, for example, the control circuit 11e adjusts the respective luminous fluxes of the three LED light source units 30 to 60 lumens, or 30 lumens. In addition, for example, the control circuit lie adjusts the respective luminous fluxes of the twelve pieces of the organic EL panel 20 to 25 lumens. In addition, for example, the control circuit 11e adjusts the respective luminous fluxes of the six pieces of first panel group to 50 lumens, and the respective luminous fluxes of the six pieces of second panel group to 25 lumens. In addition, the adjusting by the control circuit lie is performed when a user operates an operation panel which is provided on the wall, or pushes a dimming button of a remote controller with respect to a light receiving surface (not shown) which is provided at the center portion on the lower surface of the fixture main body 10.

In addition, the first embodiment maybe a case in which the organic EL panel 20 and the LED light source unit 30 have different intensity of luminous fluxes.

Here, as described above, a total area of the opening area of the six opening portions 40 which are illustrated in FIGS. 1 to 3 is set to an area of 10% or more with respect to an area of the fixture main body 10. Specifically, the opening portions 40 are formed in a region which is interposed between two concentric circles of which the lengths of radii are different from each other around the center of the center portion of the fixture main body 10. For example, as illustrated in FIG. 8, in a region which is interposed between two concentric circles of which the lengths of radii are different by 60 mm, the opening portions 40 are formed in a shape which is surrounded by an arc in which the length of chord in the inner concentric circle is 100 mm, an arc in which the length of chord in the outer concentric circle is 190 mm, and two lines which connect the two arcs at both ends. The total opening area of the six opening portions 40 which are formed in a shape which is exemplified in FIG. 8 is an area of approximately 15% of the area of the fixture main body 10.

In addition, the shape and dimension of the above described opening portion 40 is merely an example, and the shape and dimension may be arbitrarily set, if the total opening area of the opening portions 40 is the area of 10% or more of the area of the fixture main body 10. In addition, the first embodiment may be a case in which the opening portions 40 are not formed in the fixture main body 10. In such a case, the organic EL panel 20 may be arranged at the position at which the opening portions 40 are formed.

As described above, according to the first embodiment, the fixture main body 10 is in a planar shape. In addition, the power supply unit (lighting circuits 11b, 11c, 11d, and control circuit 11e, or the like) is arranged on the upper surface which is the side facing to the attaching target to which the fixture main body 10 is attached, and in the center portion of the fixture main body 10. The organic EL panel 20 is arranged on a plane, is connected to the power supply unit, and radiates light in the lower surface direction at least which is the opposite side to the side facing to the attaching target.

Portions which are mainly viewed by a user who is present in the lower surface direction of the lighting fixture 1 according to the first embodiment are the fixture main body 10 with a planar shape, and the organic EL panel 20, and both are members which can be formed thinner than the power supply unit. For this reason, the lighting fixture 1 according to the first embodiment can be formed having an appearance of a thin shape as a lighting fixture, and providing a comfortable ambient atmosphere to a user.

In addition, according to the first embodiment, the LED light source unit 30 is arranged at the center portion of the fixture main body 10 by protruding to the upper surface side, is connected to the power supply unit, and radiates light in the lower surface direction using the light distribution angle which is smaller than that of the organic EL panel 20. In addition, the organic EL panel 20 is arranged in the peripheral portion which is the periphery of the center portion of the fixture main body 10.

The organic EL panel 20 which is the surface light source can entirely illuminate a space by having a wide light distribution angle, however, it is difficult to obtain sufficient brightness using only the luminous flux of the organic EL panel 20. According to the first embodiment, it is possible to make up for the insufficient brightness using only the luminous flux of the organic EL panel 20 by arranging the organic EL panel 20 in the peripheral portion, and arranging the LED light source unit 30 at the center portion.

In addition, it is possible to illuminate the entire space using the organic EL panel 20, and to illuminate a portion which is immediately below the fixture main body 10 further brightly using the LED light source unit 30 by making the light distribution angle of the LED light source unit 30 smaller than that of the organic EL panel 20. For example, according to the first embodiment, light which radiates light immediately below the lighting fixture 1 is condensed by adjusting the light distribution angle of a beam which is radiated from the plurality of LED light source units 30 which are arranged at the center portion of the fixture main body 10. As a result, the lighting fixture 1 according to the first embodiment can provide practical brightness. For example, according to the first embodiment, it is possible to obtain the practical brightness of 300 lux to 700 lux on a table which is located at a position of 2 m immediately below the fixture by adding brightness of approximately 3000 candela (approximately 3000 cd) of the LED light source unit 30 to brightness of the organic EL panel 20.

In addition, since the reflective plate 30d and the lens 30e are provided at the LED light source unit 30 in order to adjust the light distribution angle, the LED light source unit 30 is thicker than the organic EL panel 20. According to the first embodiment, it is possible to provide comfortable feelings in appearance for a user by maintaining the lower surface side of the fixture main body 10 to a planar shape, by arranging the LED light source unit 30 so as to be protruded to the upper surface side at the center portion of the fixture main body 10.

In addition, according to the first embodiment, the luminous flux of the entire organic EL panel 20 has approximately the same intensity as luminous flux of the entire LED light source unit 30, it is possible to make the brightness in immediately below, and in the peripheral portion of the lighting fixture 1 approximately the same.

In addition, according to the first embodiment, the opening portions 40 which are formed on the plane of the fixture main body 10, and of which the opening area has a predetermined ratio or more to the area of the plane are provided. There is a case in which when the plurality of organic EL panels 20 are arranged on a plane, the area of the fixture becomes large, and gives stress to a user. According to the first embodiment, it is possible to provide the lighting fixture 1 which provides a pleasant atmosphere for a user by providing the opening portions 40 of a predetermined rate or more of not giving a user sense of pressure (for example, 10% or more) in the fixture main body 10. In addition, by providing the opening portions 40 in the fixture main body 10, it is possible to lighten the weight of fixture, and to obtain an effect of reducing cost by utilizing less materials as well.

### SECOND EMBODIMENT

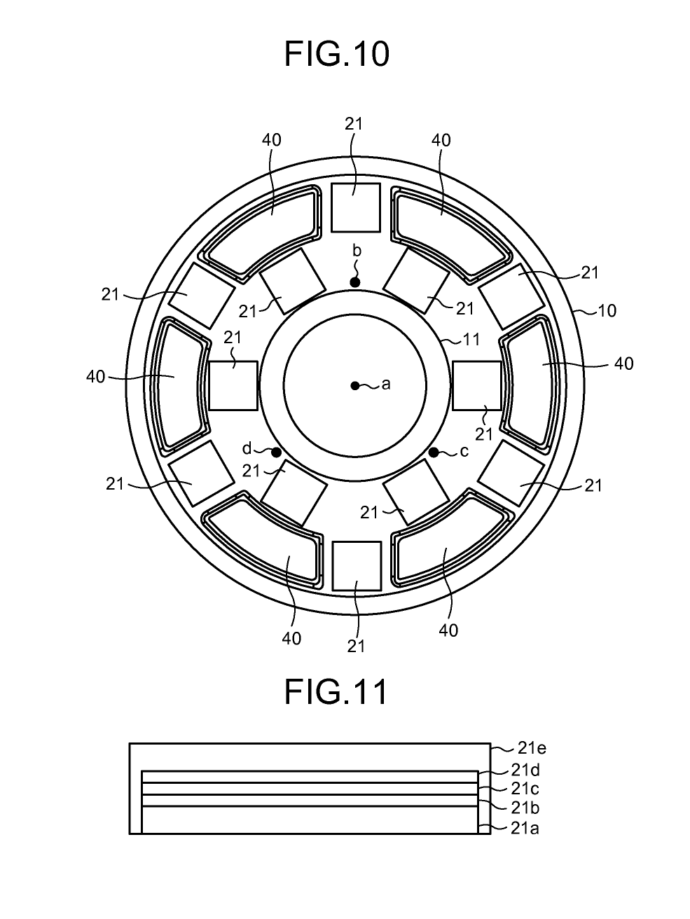

First, an appearance of a lighting fixture according to a second embodiment will be described using FIGS. 9 and 10. FIG. 9 is a perspective view of the lighting fixture according to the second embodiment, and FIG. 10 is a top view of a fixture main body which is included in the lighting fixture according to the second embodiment. In FIGS. 9 and 10, the same constituent elements as those in the lighting fixture 1 according to the first embodiment are given the same reference numerals.

A lighting fixture 2 according to the second embodiment includes a fixture main body 10, a LED light source unit 30, and an opening portion 40, as illustrated in FIGS. 9 and 10. In addition, as illustrated in FIG. 10, a center cover 11 which accommodates a power supply unit, or a part of the LED light source unit 30 is attached to a center of an upper surface of the fixture main body 10. In addition, as illustrated in FIGS. 9 and 10, six opening portions 40 are formed in the fixture main body 10. For this reason, as illustrated in FIG. 9, a part of wires 50 is viewed by a user through the opening portions 40.

In addition, as illustrated in FIG. 9, the fixture main body 10 is connected to an attaching portion 70 through the three wires 50. In addition, the attaching portion 70 is supported in a state of being directly attached to a ceiling plane which is not shown. In addition, a power line 60 which is illustrated in FIG. 9 is connected to the power supply unit which is accommodated in the center cover 11, and is inserted into a power supply terminal block in the attaching portion 70. In addition, in the second embodiment, as well, three LED light source units 30 are provided in the center cover 11. In addition, the fixture main body 10 may be attached to the ceiling plane by being embedded. In addition, an attaching target to which the fixture main body 10 is attached may be, for example, a post, or the like, without being limited to the ceiling plane.

The lighting fixture 2 according to the second embodiment includes an organic EL panel 21 instead of the organic EL panel 20 which is included in the lighting fixture 1 according to the first embodiment. In addition, as illustrated in FIG. 9, similarly to the organic EL panel 20 according to the first embodiment, six organic EL panels 21 are arranged as a first panel group which surrounds the periphery of the center portion of the fixture main body 10, and six organic EL panels 21 are arranged as a second panel group which surrounds the first panel group. For example, the organic EL panels 21 are arranged at an opening portion for panel which is formed in the fixture main body 10. In addition, for example, the organic EL panel 21 is manufactured as a cassette which can be individually exchanged.

In addition, a bottom view and a side view of the fixture main body 10 according to the second embodiment are the same as those in the first embodiment excepting that the organic EL panel 21 is arranged instead of the organic EL panel 20.

According to the second embodiment, the organic EL panel 21 which is arranged in the periphery of the center portion of the fixture main body is a transparent state when the light gets turned off. That is, the organic EL panel 21 is a transparent organic EL panel. For this reason, as illustrated in FIG. 9, a part of the wires 50 can be viewed by a user also from the organic EL panel 21, not only from the opening portions 40. In addition, as illustrated in FIG. 10, twelve organic EL panels 21 are viewed by a user also from the upper surface of the fixture main body 10. In addition, the organic EL panel 21 is configured so as to radiate in the lower surface direction of the fixture main body 10 at least when the light gets turned on.

FIG. 11 is a diagram which illustrates a configuration example of the organic EL panel which is included in the lighting fixture according to the second embodiment. As illustrated in FIG. 11, the organic EL panel 21 is configured by a substrate 21a, an organic EL element in which an anodic layer 21b, an organic EL light emitting layer 21c, and a cathode layer 21d are laminated on the substrate 21a, and a sealing member 21e. In addition, the anodic layer 21b, the organic EL light emitting layer 21c, and the cathode layer 21d are airtightly sealed by the plate-shaped sealing member 21e which is adhered to the outer peripheral portion of the substrate 21a using an adhesive. Here, the substrate 21a, the anodic layer 21b, and the organic EL light emitting layer 21c are configured similarly to the substrate 20a, the anodic layer 20b, and the organic EL panel 20 which are described using FIG. 5A.

On the other hand, the cathode layer 21d is, for example, formed of metal with high reflectivity of light, and formed on a formation region of the organic EL light emitting layer 21c in a state in which aluminum, magnesium, a magnesium-aluminum alloy, or the like, is made thin lines. In addition, the sealing member 21e is formed of, for example, glass with a high transmittance property. For example, the organic EL panel 21 is configured with the same dimension as that in the organic EL panel 20 which is illustrated in FIG. 5B.

In this manner, the organic EL panel 21 is an approximately transparent state when the light gets turned off, and irradiates mainly the lower surface direction of the fixture main body 10 with light when the light gets turned on by forming the cathode layer 21d using the thin lines, and forming the sealing member 21e using a material with a high transmittance property.

In addition, even in the second embodiment, the light distribution angle of light which is radiated to the lower surface direction from the LED light source unit 30 is set to a light distribution angle which is smaller than a light distribution angle of the organic EL panel 21 by the reflective plate 30d and the lens 30e. In addition, the luminous flux of the entire organic EL panel 21 has approximately the same intensity as luminous flux of the entire LED light source unit 30, even in the second embodiment.

In addition, dimensions and shapes of the fixture main body 10, the center cover 11, the LED light source unit 30, and the opening portions 40 according to the second embodiment are the same as the dimensions and shapes of the center cover 11, the LED light source unit 30, and the opening portions 40 which are described in the first embodiment. However, these dimensions and shapes are merely examples, and the dimensions and shapes of the fixture main body 10, the center cover 11, the LED light source unit 30, and the opening portions 40 according to the second embodiment can be changed to arbitrary dimensions and shapes. However, it is preferable that an opening area of the opening portion 40 be formed so as to be, for example, 10% or more of a planar area of the fixture main body 10.

In addition, a dimension and a shape of the organic EL panel 21 according to the second embodiment are the same as those of the organic EL panel 20 which is described in the first embodiment. However, the dimension and shape of the organic EL panel 21 according to the second embodiment can be changed to an arbitrary dimension and shape.

In addition, the second embodiment maybe a case in which the power supply unit, or the LED light source unit 30 is arranged at the center of the upper surface of the fixture main body 10 without attaching the center cover 11.

In addition, the number of pieces, and arranging positions of the organic EL panels 21 in FIG. 9 are merely examples, and the number of pieces, and the arranging positions of the organic EL panels 21 which is arranged in the peripheral portion are not limited to these. In addition, the number, and arranging positions of the LED light source units 30 are merely examples, and the number, and the arranging positions of the LED light source units 30 which are arranged at the center portion are not limited to these.

In addition, the second embodiment maybe a case in which the LED light source unit 30 is not provided as a light source. In such a case, the organic EL panel 21 may be arranged at the center portion, as well. In addition, the second embodiment may be a case in which the light distribution angle of light which is radiated to the lower surface direction from the LED light source unit 30 is not adjusted to be smaller than the light distribution angle of the organic EL panel 21. In addition, the second embodiment may be a case in which the organic EL panel 21 and the LED light source unit 30 have different intensity of luminous fluxes. In addition, the second embodiment may be a case in which the opening portions 40 are not formed in the fixture main body 10.

As described above, the organic EL panel 21 which is included in the lighting fixture 2 according to the second embodiment is a transparent state when the light gets turned off. In addition, the organic EL panel 21 radiates light in the lower surface direction of the fixture main body 10 at least when the light gets turned on. According to the second embodiment, it is possible to reduce the stress of a user since the ceiling plane is viewed from the fixture main body 10 when the light gets turned off, by mounting the organic EL panel 21 which is transparent when the light gets turned off on the lighting fixture 2. As a result, according to the second embodiment, it is possible to provide the lighting fixture 2 which provides a pleasant atmosphere to a user.

In addition, by configuring the organic EL panel 21 so as to irradiate the lower surface direction of the fixture main body 10 with light when the light gets turned on, it is possible to efficiently use light emitting of the organic EL panel 21 as light.

In addition, according to the second embodiment, it is possible to further relieve the sense of pressure of a user since the ceiling plane is viewed from the fixture main body 10 when the light gets turned on and off, by providing the opening portions 40 in the fixture main body 10 along with the organic EL panel 21, similarly to the first embodiment.

Here, as a modification example, in the second embodiment, the organic EL panel 21 may be configured so as to radiate the lower and upper surface directions of the fixture main body 10 when the light gets turned on. In such a case, the cathode layer 21d is formed of IZO with a transmittance property. In the modification example, it is possible to increase feeling of brightness in the whole room since the ceiling plane is viewed from the fixture main body 10 when the light gets turned off, and the ceiling plane is also radiated when the light gets turned on.

In addition, in the second embodiment, as a modification example, the organic EL panel 20 and the organic EL panel 21 may be arranged by being mixed. For example, the second embodiment may be a case in which the organic EL panel 20 is set to a first panel group, and the organic EL panel 21 is set to a second panel group, thereby being arranged. Even in such a case, it is possible to relive sense of pressure of a user.

In addition, the lighting fixture 2 according to the second embodiment is needed to be configured so that the ceiling plane is viewed from the organic EL panel 21, the fixture main body 10 is formed using rigid resin with a transmittance property, or the like. Alternatively, according to the second embodiment, a fixture main body 10 which is formed using metal may be used. In such a case, the opening portion is formed at a position facing the opening portion for panel on the upper surface of the fixture main body 10.

However, the second embodiment may be a case in which the opening portion for panel is not provided. The organic EL panel 21 may be mounted on the lower surface of the fixture main body 10 which is formed using a material with a transmittance property from above. In addition, the second embodiment may be a case in which, for example, the plurality of organic EL panels 21 are arranged on a doughnut shaped plate which is formed using a material with a transmittance property, and the plate is attached to the lower surface of the fixture main body 10. In addition, according to the second embodiment, a case in which there is no level difference between the lower surface of the organic EL panel 21 and the lower surface of the fixture main body 10 is described. However, the second embodiment may be a case in which, for example, the lower surface of the organic EL panel 21 slightly protrudes to the lower surface direction of the fixture main body 10. In addition, the second embodiment may be a case in which the organic EL panel 21 is not manufactured as a cassette which can be individually exchanged.

In the second embodiment, the contents which are described in the first embodiment are applied except for the organic EL panel 21 where the transparent organic EL panel is used.

As described above, according to the first and second embodiments, it is possible to provide a comfortable feeling in appearance for a user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A lighting fixture comprising:
a fixture main body with a planar shape;
a power supply unit which is arranged on an upper surface which is a side facing to an attaching target to which the fixture main body is attached, and in a center portion of the fixture main body; and
an organic Electro-Luminescence panel which is arranged at the fixture main body, is connected to the power supply unit, and radiates light in a direction of a lower surface at least which is a side opposite to the side facing to the attaching target.

2. The lighting fixture according to claim 1, further comprising:
a light emitting diode light source unit which is arranged at a center portion of the fixture main body by protruding from the upper surface side to the side facing to the attaching target, is connected to the power supply unit, and radiates light in the lower surface direction using a light distribution angle which is smaller than a light distribution angle of the organic Electro-Luminescence panel,
wherein the organic Electro-Luminescence panel is arranged at a peripheral portion which is a periphery of the center portion of the fixture main body.

3. The lighting fixture according to claim 2,
wherein the organic Electro-Luminescence panel and the light emitting diode light source unit have approximately the same intensity of luminous flux.

4. The lighting fixture according to claim 1,
wherein the organic Electro-Luminescence panel is a transparent state when the light gets turned off.

5. The lighting fixture according to claim 4,
wherein the organic Electro-Luminescence panel radiates light in directions of the lower surface and the upper surface when the light gets turned on.

6. The lighting fixture according to claim 1, further comprising:
an opening portion which is formed on a plane of the fixture main body, and of which an opening area has a predetermined ratio or more to an area of the plane.
